(19) United States
(12) Patent Application Publication
(10) Pub. No.: US 2013/0163258 A1
(43) Pub. Date: Jun. 27, 2013

(54) LENS FOR UNIFORM ILLUMINATION

(71) Applicant: Te Lung Tang, New Taipei City (TW)

(72) Inventor: Te Lung Tang, New Taipei City (TW)

(73) Assignees: Dongguan Ledlink Optics, Inc.; Yangzhou Ledlink Optics, In; Ledlink Optics, Inc.

(21) Appl. No.: 13/433,366

(22) Filed: Mar. 29, 2012

(30) Foreign Application Priority Data
Dec. 22, 2011 (TW) 100147911

(51) Int. Cl. F21V 13/04

(52) U.S. Cl. 362/327

(57) ABSTRACT

A lens for uniform illumination for a light source includes a light guide body and a reflector. The light guide body includes a side surface, an incident surface and an emitting surface opposite to the incident surface, a trough next to the incident surface having a first wall, and a tapered space next to the emitting surface having a second wall. When the light source emits light, the light is refracted from a first wall of the trough to a second wall of the tapered space. The light is totally reflected by the second wall, travels to the side surface, and is reflected by the reflector over the second wall, then refracted at the second wall to pass through the light guide body. Therefore, the light from the light source is spread out effectively and the luminous efficiency of the light source is enhanced.

This application claims the benefit of the filing date of Taiwan Patent Application No. 100147911, filed on Dec. 22, 2011, in the Taiwan Intellectual Property Office, the disclosure of which is incorporated herein in its entirety by reference.

### BACKGROUND OF THE INVENTION

1. Field of the Invention

The present invention relates to an optical device, and more particularly relates to a lens with total reflection.

2. Description of the Prior Art

A lighting equipment is necessary in our daily life and the lighting equipment with better illuminance and lower power consumption has been developed as the technology advances. Now, the most popular light source is Light-Emitting Diode (LED) which is also a semiconductor component. The LED which generates cold light is energy saving, eco-friendly and featured by a long life cycle, low heat generation and no ultraviolet ray irradiation. Therefore, LED would gradually replace the traditional light source.

Due to the property of LED described above, the current trend is towards using the LED device with an improved structure to replace the conventional tungsten bulb. Especially under the advocacy of the energy saving and carbon reduction, the energy saving advantage of the LED is more and more significant. Because the fossil fuel is decreasing and the issue of environmental protection resumes, the LED is deeply concerned and favorable. Therefore, there are various kinds of LED lighting equipments available in the market.

In the past, the LED could not compete with the traditional light source in the illumination, while the LED with high illuminance (high power LED) has been developed to replace the traditional light source. However, since the light emitting area of the LED is small and the light from the LED is generally a point source of light, a uniform luminance can hardly be achieved. This limits the utilization of the LED.

As a conventional technique, a light guide component is used to guide and spread the light generated by the LED, such that a uniform light output can be obtained in a specific range. Unfortunately, the light output from the emitting surface of the light guide component is undesirably attenuated and the light of the LED cannot be spread efficiently. Therefore, the conventional light guide component applied in the LED still cannot solve the problem of the non-uniformity of the LED.

### SUMMARY OF THE INVENTION

In view of the forgoing problems, the present invention provides a lens for uniform illumination that can solve the problem of light attenuation from the emitting surface of the light guide component of the LED.

A lens for uniform illumination used with a light source includes a light guide body and a reflector. The light guide body includes a side surface surrounding the light guide body, an incident surface and an emitting surface opposite to the incident surface, a trough next to the incident surface and having a first wall, and a tapered space next to the emitting surface and having a second wall. The light source transmitting light is close to the incident surface of the light guide body. The reflector is provided over the side surface. The light from the light source is transmitted through the first wall where the refraction occurs and totally reflected by the second wall to the side surface. Then, the light is reflected by the side surface, passes through the second wall and transmitted outward from the emitting surface.

A lens for uniform illumination, used with a light source includes a light guide body and a reflector. The light guide body includes a side surface, an incident surface and an emitting surface opposite to the emitting surface, a trough next to the incident surface and having a first wall defined by a first function y=L₁(x), and a tapered space next to the emitting surface and having a second wall defined by a second function y=L₂(x), the light source being close to the incident surface with a distance d, the length of the light source being L, wherein light is transmitted from the light source through the first wall at a first refractive index n₁ and a first angle of incidence α₁ and refracted to the second wall at a second refractive index n₂ and a refracted angle α₂, a first angle θ₁ is given between a first normal line with respect to the first angle of incidence α₁ and the refracted angle α₂ and a central axis C of the light guide body, the first normal line intersects the first function at a point (x₁, y₁) in a plane rectangular coordinate system with an intersection of the central axis C and the incident surface as an origin, the light is reflected from the second wall with a second angle of incidence β₁, and a second angle θ₂ is given between a second normal line with respect to the second angle of incidence β₂ and the central axis C of the light guide body. The reflector is provided over the side surface. Wherein the light is transmitted through the first wall and refracted to the second wall, then totally reflected by the second wall to the side surface and transmitted from the side surface through the second wall and emitted from the emitting surface, where

β₁=tan⁻¹ [L₁′(x₁)]+sin⁻¹ {(n₁/n₂)* sin−[tan⁻¹ [(L/2+x₁)/(d+y₁)]+tan⁻¹ [L₁′(x₁)]]}−tan⁻¹ [L₂′(x₂)].

The effect of the present invention can be achieved by particularly manipulating the profiles of the first wall of the trough and the second wall of the tapered trough such that the total reflection occurs within the light guide body. Because of the total reflection, the light attenuation is minimized and the light is spread out uniformly. So an improved and satisfactory luminous efficiency of the light source is obtained on the whole.

### BRIEF DESCRIPTION OF THE DRAWINGS

FIG. 1A is a 3-dimensional view of a lens in a first preferred embodiment of the present invention.

FIG. 1B is a side view of the lens in the first preferred embodiment of the present invention.

FIG. 1C is a vertical view of the lens in the first preferred embodiment of the present invention.

FIG. 1D is a section A-A view of FIG. 1C.

FIG. 2A is a schematic view of a light path in the first preferred embodiment of the present invention.

FIG. 2B is a relation drawing of the normal line and the angle in the first preferred embodiment of the present invention.

FIG. 2C is a partial enlarge drawing of FIG. 2A.

FIG. 2D is a partial enlarge drawing of the first wall in the first preferred embodiment of the present invention.

FIG. 3 is a cross-sectional view of the light guide body in the second preferred embodiment of the present invention.

FIG. 4 is a side view of the light guide body in the third preferred embodiment of the present invention.

### DETAILED DESCRIPTION OF THE INVENTION

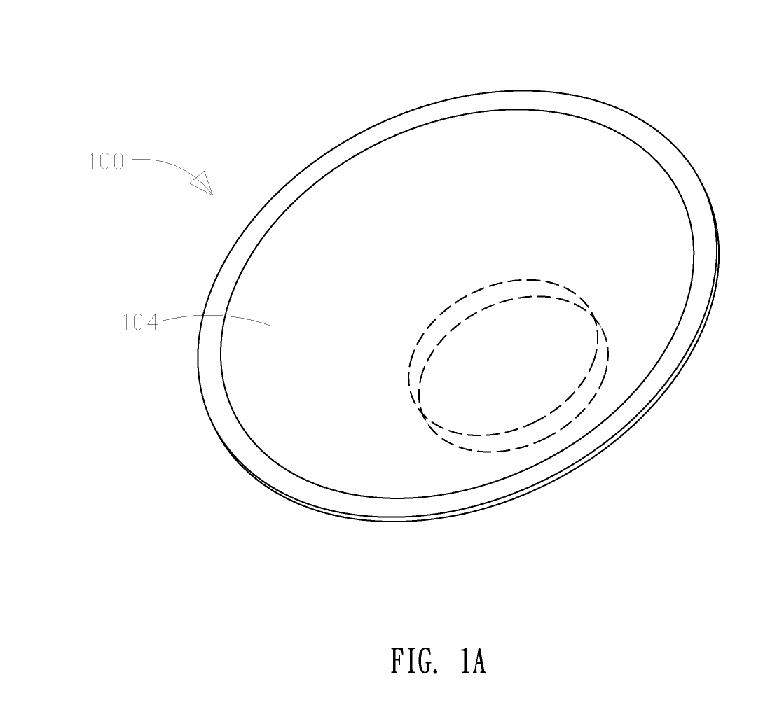

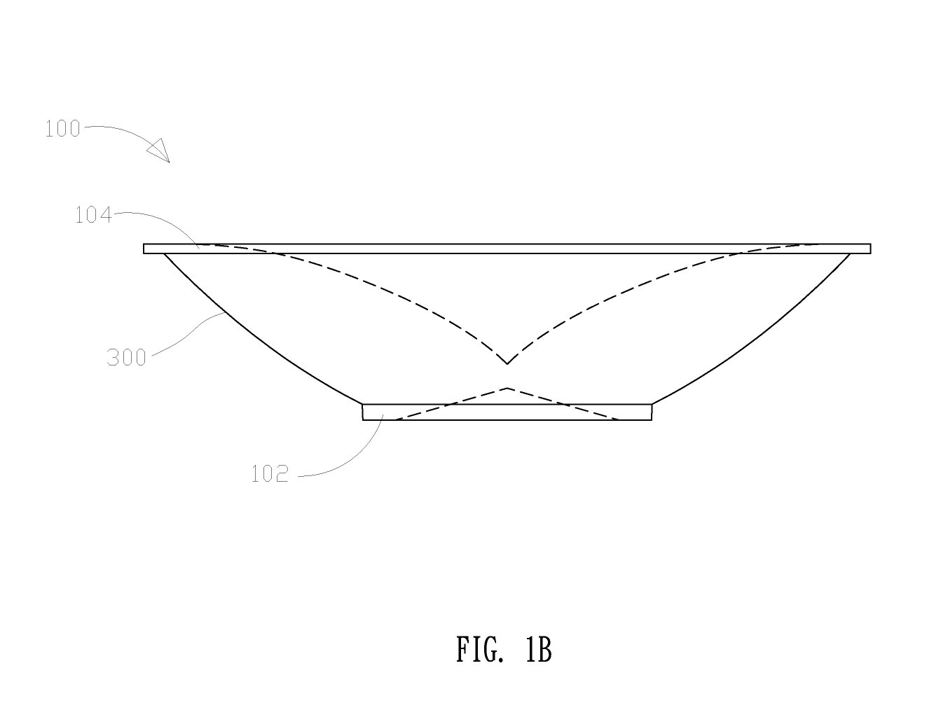

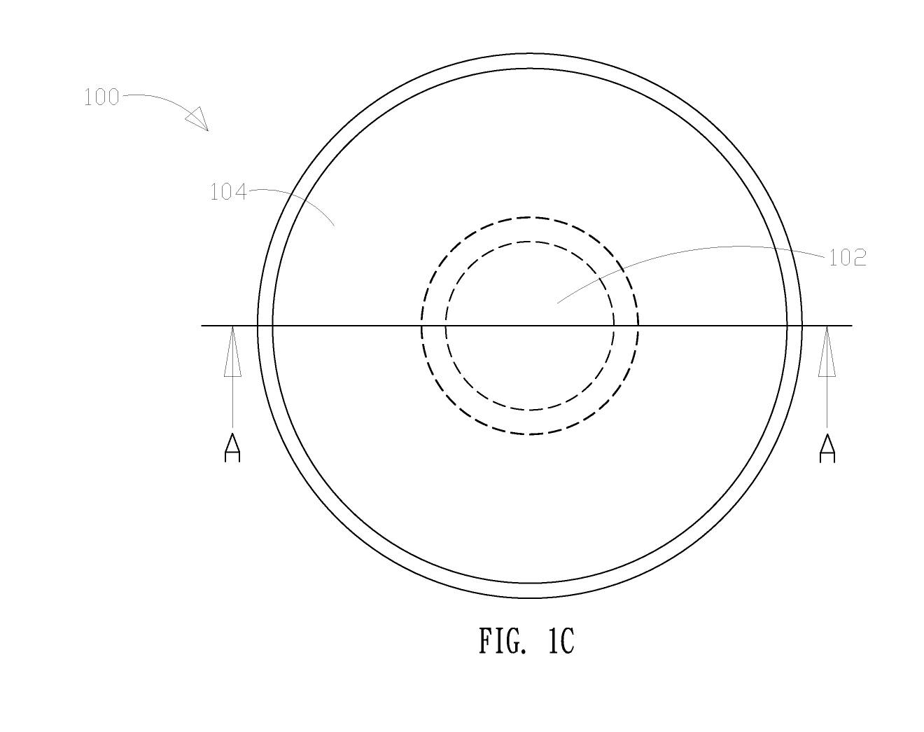

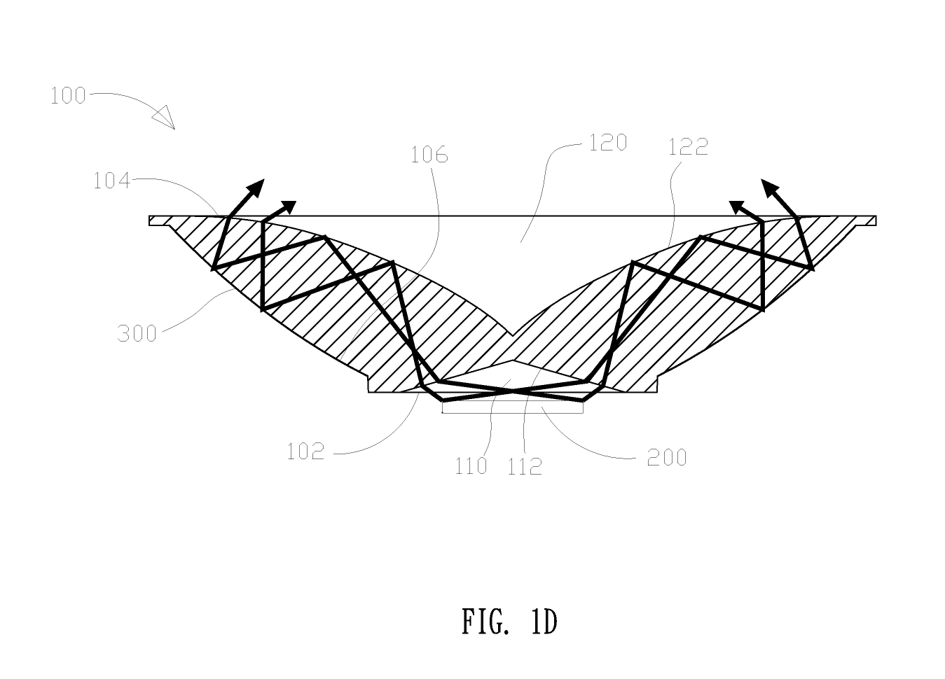

FIGS. 1A to 1D are respectively a 3-dimensional view, side view, vertical view and sectional view of FIG. 1C taken along the A-A line of the lens in a first preferred embodiment of the present invention.

As shown in the figures, the lens in the first preferred embodiment is implemented in a light source 200 which is a light-emitting diode (LED). The LED outputs light from the side surface, but a person having ordinary skill in the art can change the type of the light source 200 in accordance with the practical requirement and it is not limited herein.

The lens in the present embodiment includes a light guide body 100 and a reflector 300. The light guide body 100 is made of acrylic, glass or any other organic translucent material that facilitates the transmittal or refraction of the light. The light guide body 100 includes an incident surface 102, an emitting surface 104 that is opposite to the incident surface 102, a side surface 106 surrounding the light guide body 100, a trough 110 immediately adjacent to the incident surface 102, and a tapered space 120 immediately adjacent to the emitting surface 104. The side surface 106 is disposed between the incident surface 102 and the emitting surface 104 and connected between the edges of the incident surface 102 and the emitting surface 104. The light source 200 is disposed closely to the incident surface 102.

The trough 110 includes a first wall 112 and may be of a tapered shape with the top point thereof facing toward the emitting surface 104. So the section of the trough 110 is a triangle and the bottom of the trough 110 is disposed on the incident surface 102. The tapered space 120 includes a second wall 122 and the top point thereof faces towards the emitting surface 104. The light mostly passes through the first wall 112 and travels upward to the second wall 122 where the light is totally reflected to the side surface 106 of the light guide body 100. The reflector 300 is provided over the side surface 106 of the light guide body 100.

When the light source 200 transmits light, the light will pass through the first wall 112 and refraction will occur within the light guide body 100. After that, total reflection occurs at the second wall 122 and the light proceeds to travel to the side surface 106 of the light guide body 100. Next, the light is reflected by the reflector 300 over the side surface 106 to the second wall 122. Finally, the light is refracted at the second wall 122 to pass through the light guide body 100.

It is to be noted that the light is totally reflected at the second wall 122 to the side surface 106. As a result, the light attenuation can be as little as possible because of the total reflection. Therefore, the light can travel a much longer distance within the light guide body 100.

The light generated by the light source 200 is reflected by the refractor 300 at the side surface of the light guide body 100, transmitted to be reflected at the second wall 122 at an angle and passes through the light guide body 100 at last. Therefore, the light will travel and spread in a wider range, and the luminous efficiency of the light source 200 is enhanced.

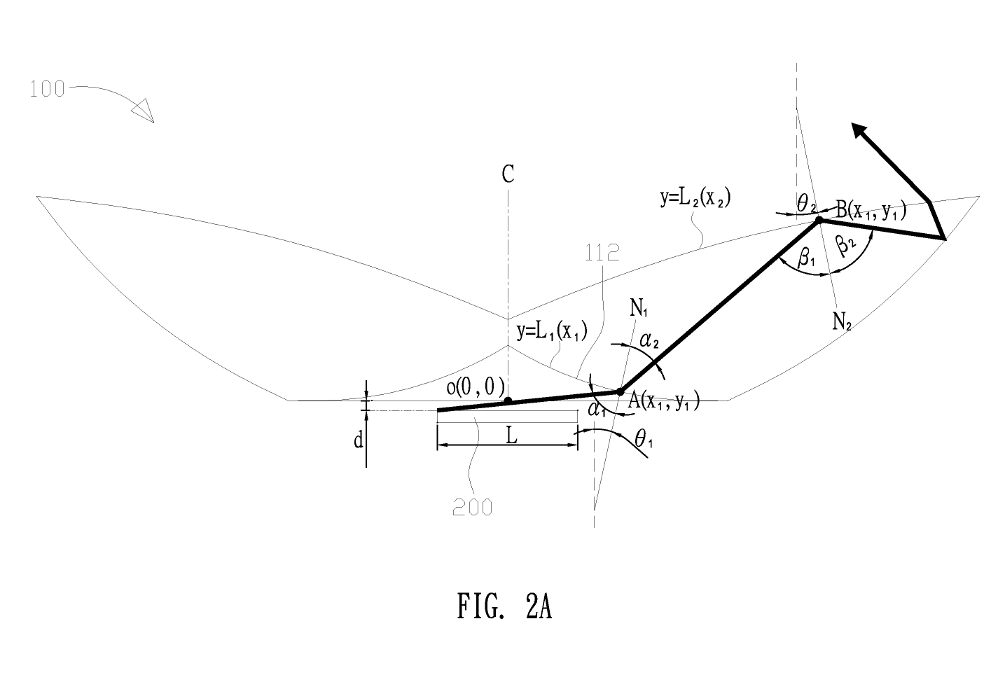

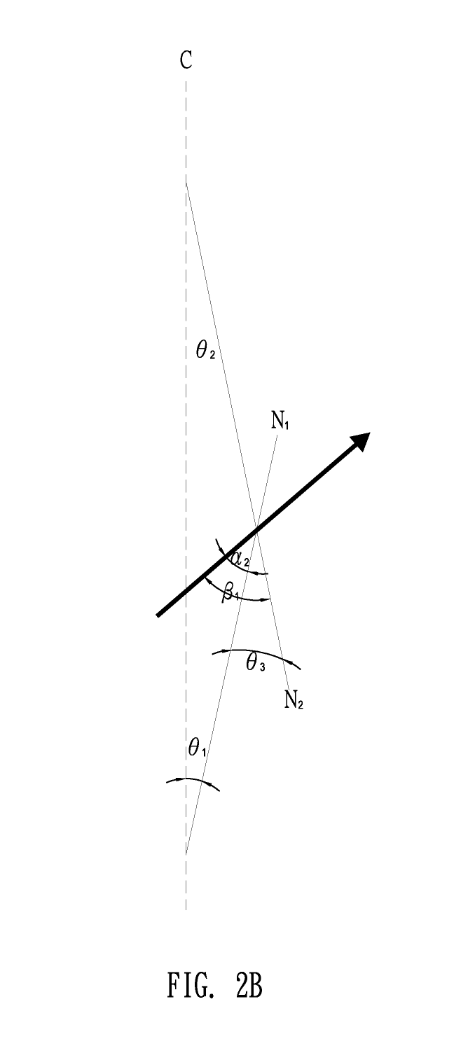

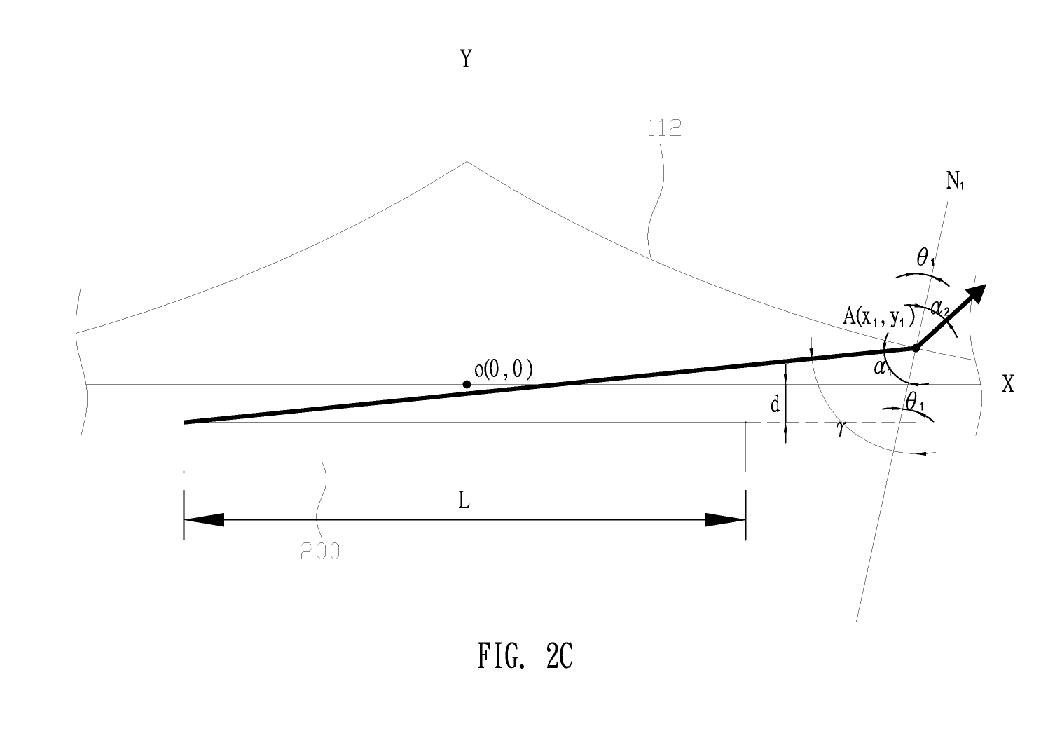

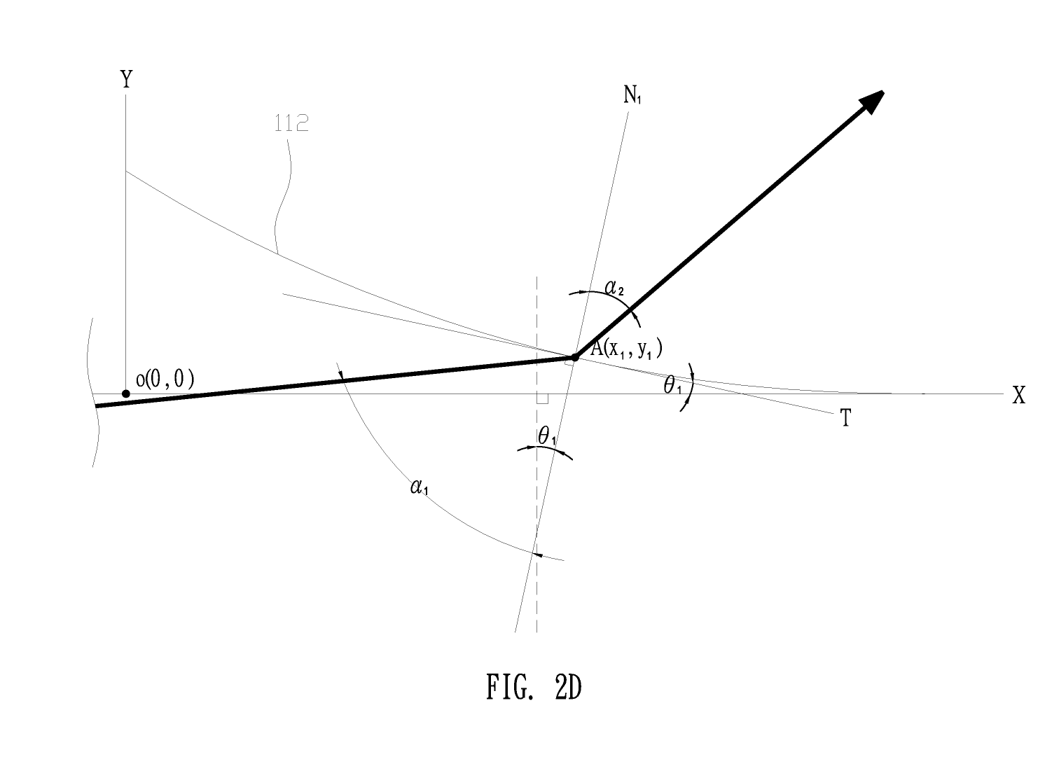

FIG. 2A is a schematic view of a light path in the first preferred embodiment of the present invention. As shown in the figure, the light guide body 100 in the present invention has a central axis C taking the center of the bottom of the light guide body 100 as the origin O(0,0) of a plane rectangular coordinate system. In this way, the central axis C is Y-axis and a horizontal line perpendicular thereto through O on the bottom of the light guide body 100 is X-axis. Both of the axes are measured in the same unit of length.

In this embodiment, the light source 200 is a LED with length L and the center of the light source 200 is located in a vertical distance d away from the bottom of the light guide body 100. Given that a light beam emitted from the light source 100 intersects the first wall 112 at a point A(x₁, y₁) and is refracted afterwards. The first wall 112 is defined by a function y=L₁(x). A first normal line N₁, a first angle of incidence α₁ and a refracted angle α₂ are associated with the point A(x₁, y₁). Besides, the angle between the first normal line N₁ and the central axis C is denoted by θ₁, the first refractive index (of air) is n₁, and the second refractive index of the light guide body 100 itself is n₂.

Subsequently, the light beam is transmitted from the first wall 112 to the second wall 122 at a second angle of incidence β₁ and intersects the second wall 122 where a total reflection occurs at a point B(x₂, y₂). The second wall 122 is defined by a function y=L₂(x). A second normal line N₂, an angle θ₂ between the second normal line N₂ and the central axis C, and an angle of reflection β₂ are associated with the point B(x₂, y₂). Next, the light beam is totally reflected by the second wall 122 to the side surface 106 of the light guide body 100 and then reflected by the reflector 300. The reflected light beam is transmitted to pass through the second wall 122.

When the light is refracted at the first side wall 112, according to Snell's law, which is n₁ sin α₁=n₂ sin α₂, the formula of α₂=sin⁻¹ [(n₁/n₂)sin α₁] is obtained.

FIG. 2B is a relationship diagram of the normal lines and angles in the first preferred embodiment of the present invention. As shown in FIG. 2A, the angle between the first normal line N₁ and the central axis C in the present invention is θ₁ and the angle between the second normal line N₂ and the central axis C is θ₁. The angles θ₁, θ₂ and the central axis C are at the same row and are also at the same row as the light reflected by the first wall 112. As shown in FIG. 2B, when point A is translated to be overlapped with point B, the refracted angle α₂ between the refracted light and the first normal N₁ and the second angle of incidence β₁ between the refracted light and the second normal line N₂ are derived. The angle between the first normal line N₁ and the second normal line N₂ is θ₃ which is equal to the summation of θ₁ and θ₂.

Therefore, the value of β₁ is the summation of the values of α₂ and θ₃; that is, the summation of α₂, θ₁ and η₂ (β₁=α₂+θ₁+θ₂). As well-known to a person skilled in the art, a rectangular coordinate is represented with the X-axis rightward and the Y-axis upward, so a counterclockwise rotation is positive and a clockwise rotation is negative. The signs of α₂ and β₁ are determined with the first normal line N1 and the second normal line N2 as the reference line respectively, while the signs of θ1 and θ2 are determined with the vertical line (parallel to the central axis C) through point A as the reference line. As a result, β₁ is negative, α₂ is negative, θ₁ is negative and θ₂ is positive. Therefore, when taking the sign of the angle into consideration, the following correlation is derived, (−β₁) =(−θ₁)+(θ₂)+(−α₂); i.e. β₁=θ₁−θ₂+α₂.

FIG. 2C is a partial enlargement of FIG. 2A. According to FIG. 1A, the length of the light source 200 is L and the center of the light source 200 is located at a vertical distance d away from the bottom of the light guide body 100. The angle between the emitted light beam from the light source 200 at point A and the first normal line N₁ is the first angle of incidence α₁. The angle between the emitted light from the light source 200 at point A and the vertical line (parallel to the central axis C) through point A is γ. The vertical line paralleled the central axis C and the angle between the vertical line and the first normal line N₁ is θ₁. As shown in the figures, correlations of tan γ=[(L/2+x₁)/(d+y₁)] and γ=tan⁻¹ [(L/2+x₁)/(d+y₁)] are derived. In addition, as shown in FIG. 2C, without the consideration of the sign of the angle, the value of γ is equal to the summation of the values of α₁ and θ₁; that is, α₁=γ−θ₁. Similarly, when taking the sign of the angle into consideration, the sign of α₁ is determined to be negative with the first normal line N₁ as the reference line. So (−α₁)=γ−(−θ₁); that is, α₁=−(γ+θ₁) and α₁=−[tan⁻¹ [(L/2+x₁)/(d+y₁)]+θ₁].

FIG. 2D is a partial curve diagram of the first wall 112 in the preferred embodiment of the present invention which is also a partial view of FIG. 2A. From FIG. 2A, the emitted light from the light source 200 intersects the first wall 112 at point A(x₁, y₁) and the light is refracted after passing through the first wall 112. As indicated above, the function of the first wall 112 is y=L₁(x), the angle between the emitted light beam from the light source 200 at point A and the first normal line N₁ is denoted as the first angle of incidence α₁, the angle between the refracted light beam and the first normal line N₁ is denoted as the refracted angle α₁, and the angle between the first normal line N₁ and the central axis C is denoted as θ₁.

Given a tangent line T L₁′(x₁) at point A (x₁, y₁) of the function y=L₁(x), since the tangent line T is also vertical to the first normal line N₁, the angle between the tangent line T and X-axis is θ₁ as well. By definition, the slope of the tangent line T is tan θ₁, thus tan θ₁=L₁′(x₁) and θ₁=tan⁻¹ [L₁′(x₁)] and θ₂=tan⁻¹ [L₂′(x₂)]. In conclusion, as shown in FIGS.

$$2 A - 2 D , {β}_{1} = {θ}_{1} - {θ}_{2} + {α}_{2} = {θ}_{1} - {θ}_{2} + {sin}^{- 1} [ ( {n}_{1} / {n}_{2} ) sin {α}_{1} ] = {tan}^{- 1} [ {L}_{1}^{′} ( {x}_{1} ) ] + {sin}^{- 1} \{ ( {n}_{1} / {n}_{2} ) * sin - [ {tan}^{- 1} [ ( L / 2 + {x}_{1} ) / ( d + {y}_{1} ) ] + {tan}^{- 1} [ {L}_{1}^{′} ( {x}_{1} ) ] ] \} - {tan}^{- 1} [ {L}_{2}^{′} ( {x}_{2} ) ] .$$

When β₁ is larger than or equal to the critical angle θc, the total reflection occurs. For example, if the lens is made of PMMA (polymethylmethacrylate, acrylic), the refractive index of PMMA is n₂=1.4935, the refractive index of air is 1, and the critical angle θc=42.034. In other words, when β₁ is larger than 42.034, total reflection occurs.

The present invention is characterized by determining the functions of the first wall 112 and the second wall 122 such that the light can be totally reflected by the second wall 122 from the first wall 112. Therefore, the light from the light source can be prevented from a rapid attenuation, thereby improving the luminous efficiency of the light source.

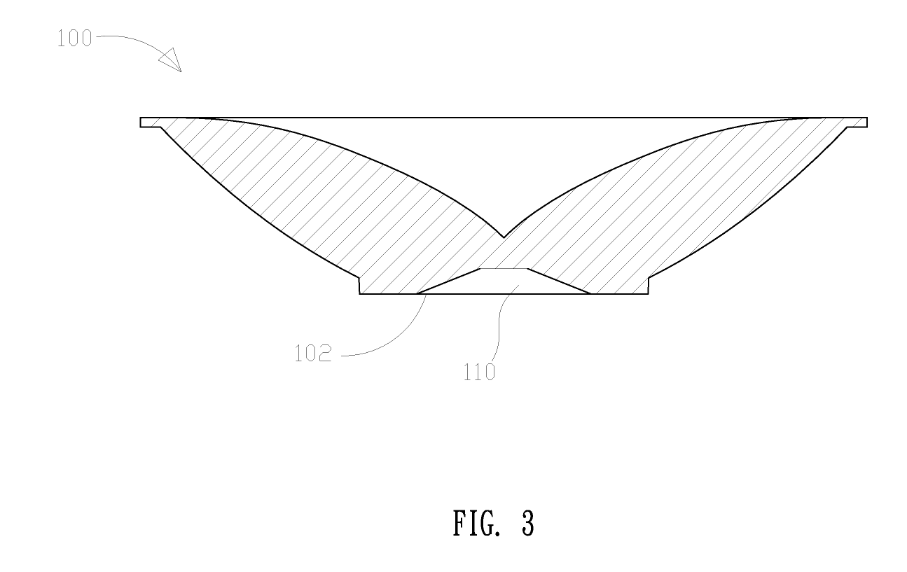

FIG. 3 is a cross-sectional view of the light guide body 100 in a second preferred embodiment of the present invention which is different from the first embodiment only in the sectional shape of the trough 110.

The section of the trough 110 in the present embodiment is a trapezoid including a top base and a bottom base having a larger length than the top base. It is noted that the bottom base is referred to the base at the side of the incident surface 102 of the light guide body 100. By comparing the first embodiment and the present embodiment, the only difference is the area of the bottom of the trough 110 based on the same slope of the first walls 112. It is noted that the area of the bottom of the trough 110 will affect the illuminance in the middle of the light guide body 100. Therefore, the area of the bottom of the trough 110 may be changed in accordance with the practical requirement.

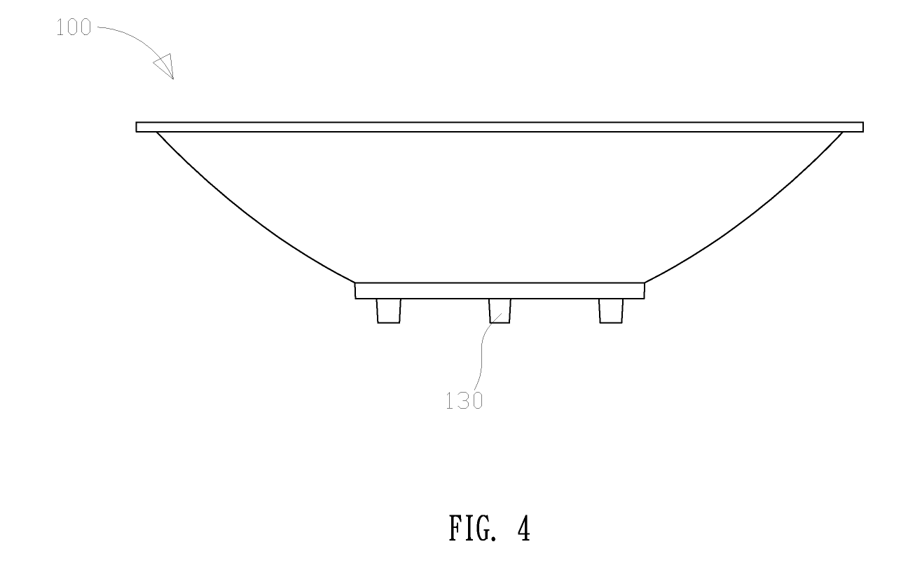

FIG. 4 is a side view of the light guide body 100 in a third preferred embodiment of the present invention. As shown in the figure, a plurality of fixing pillars 130 are provided to the bottom of the light guide body 100. The number of the fixing pillars 130 in this embodiment is three for illustration.

The fixing pillar 130 is located around the light source 200 and facilitates to keep a gap between the light source 200 and the light guide body 100. The gap may be beneficial to an enhanced heat dissipation effect and a more suitable angle of incidence when the light travels to the first wall 112. Therefore, the lens in the present invention has a high luminous efficiency. It is noted that the height of the fixing pillar is adjustable in accordance with the practical requirement.

In summary, the goal of the invention is realized by manipulating the profiles of the first wall of the trough and the second wall of the tapered space with the aid of the reflector. The total reflection and the subsequent reflection will occur within the light guide body, so that the light attenuation is minimized, the light is spread out uniformly, and the luminous efficiency of the light source is improved on the whole.

The present invention has been disclosed as mentioned-above and it is understood the embodiments are not intended to limit the scope of the present invention. Moreover, as the contents disclosed herein should be readily understood and can be implemented by a person skilled in the art, all equivalent changes or modifications which do not depart from the spirit of the present invention should be encompassed by the appended claims.

What is claimed is:

1. A lens for uniform illumination, used with a light source, comprising:
a light guide body including a side surface, an incident surface and an emitting surface opposite to the incident surface, a trough next to the incident surface and having a first wall, and a tapered space next to the emitting surface and having a second wall, the light source being close to the incident surface; and
a reflector provided over the side surface,
wherein light is transmitted from the light source through the first wall and refracted to the second wall, then totally reflected by the second wall to the side surface and transmitted from the side surface through the second wall and emitted from the emitting surface.

2. The lens as in claim 1, wherein a section of the trough is a triangle and a bottom of the trough is located on the incident surface.

3. The lens as in claim 1, wherein a section of the trough is a trapezoid with a bottom base having a larger length than a top base, and a bottom of the trough is overlapped with the incident surface.

4. The lens as in claim 1, further comprising a plurality of fixing pillars provided to the light guide body.

5. A lens for uniform illumination, used with a light source, comprising:
a light guide body including a side surface, an incident surface and an emitting surface opposite to the emitting surface, a trough next to the incident surface and having a first wall defined by a first function y=L₁(x), and a tapered space next to the emitting surface and having a second wall defined by a second function y=L₂(x), the light source being close to the incident surface with a distance d, the length of the light source being L, wherein light is transmitted from the light source through the first wall at a first refractive index n₁ and a first angle of incidence α₁ and refracted to the second wall at a second refractive index n₂ and a refracted angle α₂, a first angle θ₁ is given between a first normal line with respect to the first angle of incidence α₁ and the refracted angle α₂ and a central axis C of the light guide body, the first normal line intersects the first function at a point (x₁, y₁) in a plane rectangular coordinate system with an intersection of the central axis C and the incident surface as an origin, the light is reflected from the second wall with a second angle of incidence β₁, and a second angle θ₂ is given between a second normal line with respect to the second angle of incidence β₂ and the central axis C of the light guide body; and
a reflector provided over the side surface;
wherein the light is transmitted through the first wall and refracted to the second wall, then totally reflected by the second wall to the side surface and transmitted from the side surface through the second wall and emitted from the emitting surface,
where
β₁=tan⁻¹ [L₁′(x₁)]+sin⁻¹ {(n₁/n₂)* sin−[tan⁻¹ [(L/2+x₁)/(d+y₁)]+tan⁻¹ [L₁′(x₁)]]}−tan⁻¹ [L₂′(x₂)].

6. The lens as in claim 5, wherein the first angle θ₁=tan⁻¹ [L₁′(x₁)].

7. The lens as in claim 5, wherein the second angle θ₂=tan⁻¹ [L₂′(x₂)].

8. The lens as in claim 5, wherein the reflected angle α₂=sin⁻¹ [(n₁/n₂)sin α₁].

9. The lens as in claim 5, wherein the first angle α₁=−(γ+θ₁), γ=tan⁻¹ [(L/2+x₁)/(d+y₁)].

10. The lens as in claim 5, wherein a section of the trough is a triangle and a bottom of the trough is located on the incident surface.

11. The lens as in claim 5, wherein a section of the trough is a trapezoid with a bottom base having a larger length than a top base and a bottom of the trough is overlapped with the incident surface.

12. The lens as in claim 5, further comprising a plurality of fixing pillars provided to the light guide body.
